(19) United States
(12) Patent Application Publication
(10) Pub. No.: US 2025/0180929 A1
(43) Pub. Date: Jun. 5, 2025

(54) WRAPAROUND, PROTECTIVE EYEWEAR FOR VIEWING SOLAR ECLIPSES

(71) Applicants: Milton L. Loeb, Little Rock, AR (US); Daniel Joel Salmore, Littleton, CO (US)

(72) Inventors: Milton L. Loeb, Little Rock, AR (US); Daniel Joel Salmore, Littleton, CO (US)

(21) Appl. No.: 18/527,182

(22) Filed: Dec. 1, 2023

(51) Int. Cl. G02C 7/16

(52) U.S. Cl. CPC G02C 7/16; G02C 7/10

(57) ABSTRACT

The present invention is a wraparound, protective eyewear for viewing solar eclipses that includes a solar filter material layer. The eyewear preferably wraps around the front of the head of a wearer and ends at the sides of the head about the area near temples and ears. The eyewear is dimensioned and configured to fully cover the eyes of the wearer and may have the appearance of a pair of glasses or sunglasses and/or a skiing goggle, especially when looking at the eyewear from the front during use. Preferably, the eyewear is collapsible or retractable when not in use. In a non-limiting, first embodiment, the eyewear may include only a solar filter material layer. In a non-limiting, preferred embodiment, the eyewear includes a solar filter material layer and at least one transparent layer that is secured or laminated to the front and/or back of the solar filter material layer.

### BACKGROUND OF THE INVENTION

### Field of the Invention

The present invention relates generally to protective eyewear and devices for use in viewing solar eclipses. More specifically, the present invention is a wraparound, protective eyewear for viewing solar eclipses comprising a solar filter material layer capable of blocking or minimizing solar radiation and effects directed to a user's eyes. Preferably, the wraparound, protective eyewear is also collapsible or retractable.

### Description of the Related Art

Protective eyewear and devices for use in viewing solar eclipses are well known in the art.

Despite its long use, it is believed that the wraparound type of eyewear has never been used before in an application capable of screening out solar radiation and solar effects, and thus there has been no application of that type of eyewear available to individuals for solar eclipse use. The Applicant has invented a new wraparound, protective eyewear for viewing solar eclipses. Preferably, the present invention is able to be used by individuals of all ages and all visual abilities, but especially individuals wearing corrective glasses and children twelve or older. The Applicant and its affiliated party(ies), such as American PaperWear of Little Rock, AR, are engaged in production and distribution of solar eclipse glasses made with paper frames.

A protective eyewear for viewing solar eclipses that partially or fully wraps around the head of a user or wearer is desired.

A protective eyewear for viewing solar eclipses that is collapsible or retractable is desired.

A protective eyewear for viewing solar eclipses that is lightweight is desired.

A protective eyewear for viewing solar eclipses that is disposable is desired.

A protective eyewear for viewing solar eclipses that is inexpensive to manufacture is desired.

The Applicant is unaware of inventions or patent documents, taken either singly or in combination, which are seen to describe the present invention as described and/or claimed.

### SUMMARY OF THE PRESENT INVENTION

The present invention is a wraparound, protective eyewear for viewing solar eclipses that comprises a solar filter material layer capable of blocking or minimizing solar radiation or solar effects directed to the eyes of a user. In a preferred embodiment, the wraparound, protective eyewear wraps around the front of the head of a wearer or user, and a first end and a second end of the eyewear end at the sides of the head about the area near temples and ears wherein each of the first end and second end preferably makes a comfortable compression or contact with the sides of the head such that the eyewear is retained (via the help of the first end, second end, and nose cutout (which is positioned or rests on (preferably), near or in proximity of the nose bridge of the user U)) on the head and face of the user during use. The solar filter material layer (preferably, the wraparound, protective eyewear also) is dimensioned and configured to fully cover the eyes of the user during use, and the wraparound, protective eyewear may have the appearance of a pair of glasses or sunglasses and/or a skiing goggle, especially when looking at the wraparound, protective eyewear from the front during use. Preferably, the wraparound, protective eyewear is collapsible or retractable when not in use.

In a non-limiting, first embodiment, the wraparound, protective eyewear may comprise only a solar filter material layer, with no additional layer(s). Preferably, the wraparound, protective eyewear is collapsible or retractable when not in use.

In a non-limiting, preferred embodiment, the wraparound, protective eyewear comprises a solar filter material layer and at least one transparent layer that is secured (such as, but not limited to, via lamination) to the front and/or back of the solar filter material layer. Preferably, the wraparound, protective eyewear is collapsible or retractable when not in use.

### BRIEF DESCRIPTION OF THE DRAWINGS

FIG. 1 is an environmental, front view of a wraparound, protective eyewear for viewing solar eclipses according to the present invention, wherein the wraparound, protective eyewear is in an extended position;

FIG. 2 is an environmental, right side view of the wraparound, protective eyewear of FIG. 1;

FIG. 3 is an environmental, left side view of the wraparound, protective eyewear of FIG. 1;

FIG. 4 is a perspective view of the wraparound, protective eyewear of FIG. 1, wherein the wraparound, protective eyewear is in a retracted or original position; and

FIG. 5 is a cross-sectional view of the wraparound, protective eyewear of FIG. 1.

It should be understood that the above-attached figures are not intended to limit the scope of the present invention in any way.

### DETAILED DESCRIPTION OF THE EMBODIMENTS OF THE PRESENT INVENTION

The present invention is a wraparound, protective eyewear 100 for viewing solar eclipses that comprises a solar filter material layer 110 capable of blocking or minimizing solar radiation or solar effects directed to the eyes of a user U. In a preferred embodiment, the wraparound, protective eyewear 100 wraps around the front of the head of a wearer or user U, and a first end and a second end of the eyewear 100 end at the sides of the head about the area near temples and ears wherein each of the first end and second end preferably makes a comfortable compression or contact with the sides of the head such that the eyewear is retained (via the help of the first end, second end, and nose cutout (which rests or is positioned on (preferably), near or in proximity of the nose bridge of the user U)) on the head and face of the user U during use. Alternatively or as one embodiment, the wraparound, protective eyewear may wrap around the entire head of a wearer or user U. The solar filter material layer 110 (preferably, the wraparound, protective eyewear 100 also) is dimensioned and configured to fully cover the eyes of the user U during use. Preferably, the wraparound, protective eyewear 100 is collapsible or retractable when not in use.

In a non-limiting, first embodiment, the wraparound, protective eyewear may comprise only a solar filter material layer 110, with no additional layer(s). Preferably, the wraparound, protective eyewear is collapsible or retractable when not in use.

The wraparound, protective eyewear of the first embodiment comprises a top surface, a bottom surface, an upper outline or edge, a lower outline or edge, a first end, a second end, and a body extending from the first end to the second end. The wraparound, protective eyewear may further comprise a nose cutout at the lower outline to allow the wraparound, protective eyewear to rest or be positioned on (preferably), near or in proximity of the bridge of the nose of the user U during use. It is preferred that each of the first end and second end of the wraparound, protective eyewear is curved and/or smooth such that it makes a gentle or comfortable compression at the area about the corresponding temple and ear when the wraparound, protective eyewear is positioned on the head and face of the user U during use. The first end, second end, and nose cutout of the wraparound, protective eyewear preferably helps the wraparound, protective eyewear stay on the head and face of the user U during use.

The solar filter material layer 110 is capable of blocking or minimizing solar radiation or solar effects directed to the eyes of a user U. It is preferred that the solar filter material layer 110 is an ISO 12312-2 compliant filter material or film. There are at least two types of ISO 12312-2 compliant filter materials or films that are currently commercially available in the U.S.: (1) a film sold commercially under the name “silver black polymer” from 1000 Oaks Optical which can be used for filtration of visible sunlight, from infrared to UV; it has a silver color on the surface; and (2) a film sold commercially under the name “SB00 Skyrol 300ga black polymer” from SKC America; it has a black color on the surface. While both products are compliant with the ISO 12312-2 safety standard, one or the other may be chosen for use based on price, availability and other commercial factors. Other known solar filter materials or solar filter material layers that is/are capable of blocking or minimizing solar radiation or solar effects directed to the eyes of a user U may possibly be used.

Preferably, the solar filter material layer 110 is dimensioned and configured to fully cover both eyes of the user Uso that the eyes and nearby tissues of the user U are not harmed from using the wraparound, protective eyewear of the present invention to view a solar eclipse(s).

As a non-limiting example, the solar filter material layer 110 comprises a top surface 112, a bottom surface 114, an upper outline or edge 116, a lower outline or edge 118, a first end 120, a second end 122, and a body 124 extending from the first end 120 to the second end 122. The solar filter material layer 110 may further comprise a nose cutout 126 at the lower outline 118 to allow the solar filter material layer 110 to rest or be positioned on (preferably), near or in proximity of the bridge of the nose of the user U during use. Preferably, the solar filter material layer 110 is made or manufactured in different dimensions and configurations to accommodate adult and child users U having heads and faces of different sizes and configurations. Preferably, during use when the wraparound, protective eyewear is extended in the extended position, the first end 120 of the solar filter material layer 110 is positioned near, about or in proximity of the area near the corresponding temple and ear while the second end 122 of the solar filter material layer 110 is positioned near, about or in proximity of the area near the other corresponding temple and ear.

Preferably, the wraparound, protective eyewear of the first embodiment collapses or retracts to a roll-up or spiral cylindrical form or shape when not in use. This helps to more easily store and/or transport the wraparound, protective eyewear when not in use.

In the first embodiment, it is preferred that the solar filter material layer 110 has a sufficient thickness and resiliency to allow it (and thus, the wraparound, protective eyewear also) to collapse or retract into a roll-up cylindrical form or shape from an extended position EP to a retracted or original position OP when not in use, and, vice versa, also to be extended or rolled back outward from the retracted or original position OP to the extended position EP when in use.

As a non-limiting example, it is preferred that the solar filter material layer 110 has a thickness of about seven (7) mils (one mil is a measurement that equals one-thousandth of an inch) to about nine (9) mils; more preferably, about eight (8) mils to about nine (9) mils; and, most preferably, about eight (8) mils.

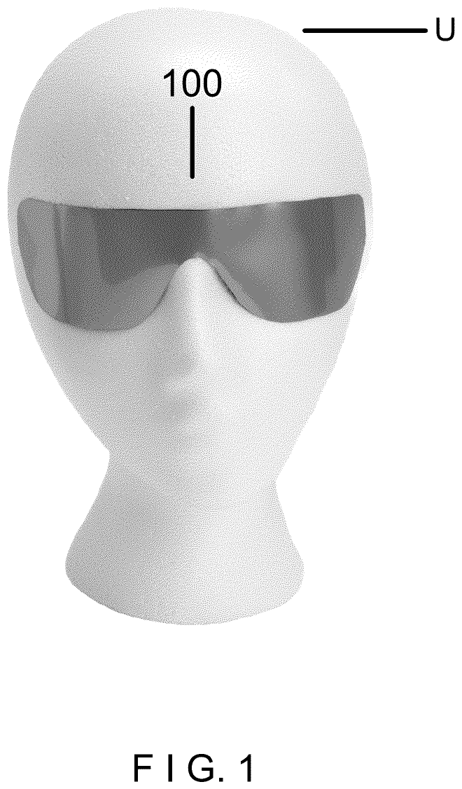

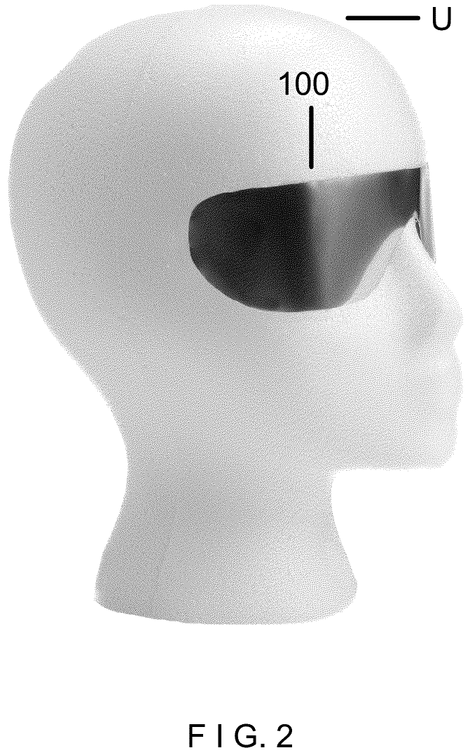

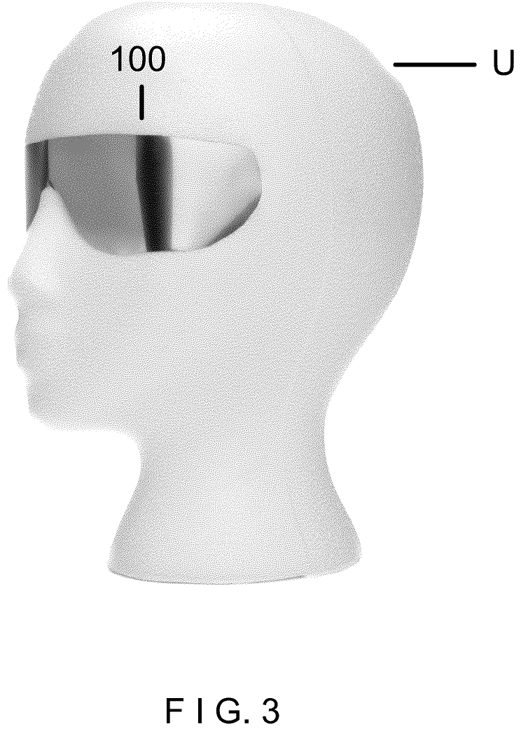

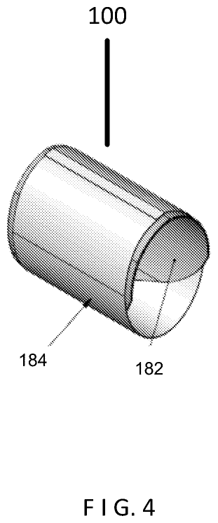

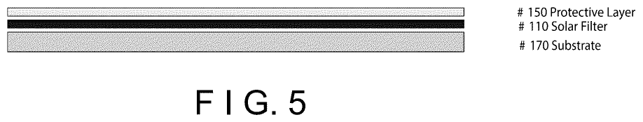

In a non-limiting, preferred embodiment and as shown in FIGS. 1-5, the wraparound, protective eyewear 100 comprises a solar filter material layer 110 and at least one transparent layer that is secured (such as, but not limited to, via lamination) to the front and/or back of the solar filter material layer 110. Preferably, the wraparound, protective eyewear 100 is collapsible or retractable when not in use.

The wraparound, protective eyewear 100 of the preferred embodiment comprises a top surface (which is preferably the top surface of a first transparent layer), a bottom surface (which is preferably the bottom surface of a second transparent layer), an upper outline or edge, a lower outline or edge, a first end, a second end, and a body extending from the first end to the second end. The wraparound, protective eyewear 100 may further comprise a nose cutout at the lower outline to allow the wraparound, protective eyewear 100 to rest or be positioned on (preferably), near or in proximity of the bridge of the nose of the user U during use. It is preferred that each of the first end and second end of the wraparound, protective eyewear 100 is curved and/or smooth such that it makes a gentle or comfortable compression at the area about the corresponding temple and ear when the wraparound, protective eyewear 100 is positioned on the head and face of the user U during use. The first end, second end, and nose cutout of the wraparound, protective eyewear 100 preferably helps the wraparound, protective eyewear 100 stay on the head and face of the user U during use.

Preferably, the solar filter material layer 110 of the preferred embodiment is substantially similar (except for maybe the thickness) or exactly the same as the solar filter material layer 110 of the first embodiment.

Preferably, the at least one transparent layer is a first transparent layer 150 and a second transparent layer 170 that are secured (such as, but not limited to, via lamination) to the front and back of the solar filter material layer 110, respectively. The first transparent layer 150 and second transparent layer 170 provide structural support to the solar filter material layer 110. Preferably, each of the first transparent layer 150 and second transparent layer 170 has a substantially similar or the same configuration as the configuration of the solar filter material layer 110 such that the three layers 110, 150, 170 are flush with one another when they are secured (such as, but not limited to, via lamination) to one another.

As a non-limiting example, the first transparent layer 150 preferably comprises a top surface 152, a bottom surface 154, an upper outline or edge 156, a lower outline or edge 158, a first end 160, a second end 162, a body 164 extending from the first end 160 to the second end 162, and a thickness. The first transparent layer 150 may further comprise a nose cutout 166 at the lower outline 158 to allow the first transparent layer 150 to rest or be positioned on (preferably), near or in proximity of the bridge of the nose of the user U during use. Preferably, the first transparent layer 150 is made or manufactured in different dimensions and configurations to accommodate adult and child users U having heads and faces of different sizes and configurations. Preferably, during use when the wraparound, protective eyewear is extended in the extended position, the first end 160 of the first transparent layer 150 is positioned near, about or in proximity of the area near the corresponding temple and ear while the second end 162 of the first transparent layer 150 is positioned near, about or in proximity of the area near the other corresponding temple and ear.

As a non-limiting example, the second transparent layer 170 preferably comprises a top surface 172, a bottom surface 174, an upper outline or edge 176, a lower outline or edge 178, a first end 180, a second end 182, a body 184 extending from the first end 180 to the second end 182, and a thickness. The second transparent layer 170 may further comprise a nose cutout 186 at the lower outline 178 to allow the second transparent layer 170 to rest or be positioned on (preferably), near or in proximity of the bridge of the nose of the user U during use. Preferably, the second transparent layer 170 is made or manufactured in different dimensions and configurations to accommodate adult and child users U having heads and faces of different sizes and configurations. Preferably, during use when the wraparound, protective eyewear is extended in the extended position, the first end 180 of the second transparent layer 170 is positioned near, about or in proximity of the area near the corresponding temple and ear while the second end 182 of the second transparent layer 170 is positioned near, about or in proximity of the area near the other corresponding temple and ear.

As a non-limiting example in this preferred embodiment, it is preferred that the three layer combination of the solar filter material layer 110, first transparent layer 150, and second transparent layer 170 has a thickness of about seven (7) mils to about nine (9) mils; more preferably, about eight (8) mils to about nine (9) mils; and, most preferably, about eight (8) mils.

As a non-limiting example in this preferred embodiment, it is preferred that each of the first transparent layer 150 and second transparent layer 170 is made or manufactured of a polymer material, a plastic material, or a combination thereof that has sufficient resiliency to allow it (and thus, the wraparound, protective eyewear 100 also) to collapse or retract into a roll-up cylindrical form or shape from an extended position EP to a retracted or original position OP when not in use, and also to be extended or rolled back outward from the retracted or original position OP to the extended position EP when in use.

Preferably, the wraparound, protective eyewear of the present invention is lightweight, disposable, and/or generally inexpensive to make or manufacture. Preferably, the wraparound, protective eyewear of the present invention has the appearance and configuration of a pair of glasses or sunglasses and/or a skiing goggle, especially when looking at the wraparound, protective eyewear from the front during use. Preferably, the wraparound, protective eyewear of the present invention is dimensioned and configured to fit flush against the face of the user U during use so that the eyes of the user U are best protected as possible and so that the wraparound, protective eyewear can be more securely retained, with the help of the first end, second end, and nose cutout of the wraparound, protective eyewear, on the head and face of the user U. Preferably, the wraparound, protective eyewear of the present invention is dimensioned and configured to fit comfortably underneath prescription eyewear for better solar eclipse viewing. Preferably, the wraparound, protective eyewear of the present invention can be manufactured or made in different dimensions and configurations to accommodate adult and child users U having heads and faces of different sizes and configurations.

As a non-limiting example of a process to create or form an embodiment of the present invention, the steps are:
(1) obtain stock master rolls of clear polyethylene terephthalate (PET) (or possibly polyethylene tetraborate) that are about three (3) mils thick and a center laminate material either from 1000 Oaks (about two (2) mils silver black) or SKC (about three (3) mils SB00 300 ga);
(2) create a sandwich material of a clear or transparent layer/a black solar filter material layer/a clear or transparent layer that is about seven (7) mils to about nine (9) mils (more preferably, about eight (8) mils to about nine (9) mils, and, most preferably, about eight (8) mils) thick;
(3) put the sandwich material into master rolls and slit to widths that are specified;
(4) put the rolls on a flexo printing press where they are marked by printing on with a UV-cured white die, and then die cut to the lens shape;
(5) load the lenses the eight axis automatic assembly machines where they are rolled up, and have a cardstock paper sleeve wrapped around them;
(6) heat treat the assembled lenses at about 325 degrees for about one minute;
(7) air cool the assembled lenses; and
(8) count and package the finished product.

As another non-limiting example of a process to create or form an embodiment of the present invention, the steps are:
(1) laminate at least one transparent layer (made or manufactured of a polymer, such as, but not limited to, polyethylene terephthalate (PET) or possibly polyethylene tetraborate) and a solar screening or filtering material layer (preferably blocks out about 99.96 percent of visible light; such as, but not limited to, an ISO 12312-2 compliant layer) together wherein the at least one transparent layer is laminated to the upper surface and/or lower surface of the solar screening or filtering material layer. Preferably, an ISO 12312-2 compliant layer is sandwiched between a first or upper transparent layer and a second or lower transparent layer, and then the three layers are laminated together to form a laminated product that is about seven (7) mils to about nine (9) mils (more preferably, about eight (8) mils to about nine (9) mils, and, most preferably, about eight (8) mils) thick;
(2) cut and form the laminated product into a cylindrical or spiral form or configuration (when in the retracted or original position) of the wraparound, protective eyewear; and
(3) optional, for commercial and/or sale purposes, provide the wraparound, protective eyewear of the present invention in a cylindrical paper sleeve for transport to consumers and sellers.

It is to be understood that the present invention is not limited to the embodiments described above or as shown in the attached figures, but encompasses any and all embodiments within the spirit of the invention.

1. A wraparound, protective eyewear for viewing solar eclipses, said wraparound, protective eyewear comprising:
a transparent, base layer comprising a top surface, a bottom surface, an upper outline or edge, a lower outline or edge, a first end, a second end, and a body extending from said first end of said transparent, base layer to said second end of said transparent, base layer; and
a solar filter material layer bonded to said top surface of said transparent, base layer,
wherein said solar filter material layer comprises a top surface, a bottom surface, an upper outline or edge, a lower outline or edge, a first end, a second end, and a body extending from said first end of said solar filter material layer to said second end of said solar filter material layer,
wherein said solar filter material layer is capable of blocking or minimizing solar radiation or solar effects directed to eyes of a user,
wherein said solar filter material layer has a thickness and is dimensioned and configured to fully cover the eyes of the wearer,
wherein said wraparound, protective eyewear is dimensioned to wrap around front of a head of the wearer, and
wherein said wraparound, protective eyewear is capable of being positioned in an extended position and being retained in a location on the head of the wearer such that the wearer can view a solar eclipse without holding said wraparound, protective eyewear with a wearer's hand.

2. The wraparound, protective eyewear according to claim 1, wherein said first end of said transparent, base layer and said second end of said transparent, base layer are positioned at corresponding sides of the head of the wearer during use when the wearer can view a solar eclipse.

3. (canceled)

4. The wraparound, protective eyewear according to claim 1, wherein said wraparound, protective eyewear is dimensioned and configured to have an appearance of a pair of glasses or sunglasses and/or a skiing goggle.

5. The wraparound, protective eyewear according to claim 1, wherein said wraparound, protective eyewear is collapsible or retractable from said extended position to a retracted position when not in use.

6. The wraparound, protective eyewear according to claim 1, wherein said solar filter material layer is an ISO 12312-2 compliant filter material or film.

7. The wraparound, protective eyewear according to claim 1, wherein said thickness of said solar filter material layer is about seven mils to about nine mils.

8. The wraparound, protective eyewear according to claim 7, wherein said thickness of said solar filter material layer is about eight mils.

9. A wraparound, protective eyewear for viewing solar eclipses, said wraparound, protective eyewear comprising:
a transparent, base layer comprising a top surface, a bottom surface, an upper outline or edge, a lower outline or edge, a first end, a second end, and a body extending from said first end of said transparent, base layer to said second end of said transparent, base layer;
a solar filter material layer bonded to said top surface of said transparent, base layer,
wherein said solar filter material layer comprises a top surface, a bottom surface, an upper outline or edge, a lower outline or edge, a first end, a second end, and a body extending from said first end of said solar filter material layer to said second end of said solar filter material layer,
wherein said solar filter material layer is capable of blocking or minimizing solar radiation or solar effects directed to eyes of a user,
wherein said solar filter material layer comprises a front surface, a back surface, and a thickness,
wherein said solar filter material layer is dimensioned and configured to fully cover the eyes of the wearer,
wherein said wraparound, protective eyewear is dimensioned to wrap around front of a head of the wearer, and
wherein said wraparound, protective eyewear is capable of being positioned in an extended position and being retained in a location on the head of the wearer such that the wearer can view a solar eclipse without holding said wraparound, protective eyewear with a wearer's hand; and
a transparent, top layer bonded to said top surface of said solar filter material layer,
wherein said transparent, top layer comprises a top surface, a bottom surface, an upper outline or edge, a lower outline or edge, a first end, a second end, and a body extending from said first end of said transparent, top layer to said second end of said transparent, top layer.

10. The wraparound, protective eyewear according to claim 9, wherein said first end of said transparent, base layer and said second end of said transparent, base layer are positioned at corresponding sides of the head of the wearer during use when the wearer can view a solar eclipse.

11. (canceled)

12. The wraparound, protective eyewear according to claim 9, wherein said wraparound, protective eyewear is dimensioned and configured to have an appearance of a pair of glasses or sunglasses and/or a skiing goggle.

13. The wraparound, protective eyewear according to claim 9, wherein said wraparound, protective eyewear is collapsible or retractable from said extended position to a retracted position when not in use.

14. The wraparound, protective eyewear according to claim 9, wherein said solar filter material layer is an ISO 12312-2 compliant filter material or film.

15. The wraparound, protective eyewear according to claim 9, wherein a total thickness of said thickness of said solar filter material layer and a thickness of at least one of said transparent, base layer and said transparent, top layer is about seven mils to about nine mils.

16. The wraparound, protective eyewear according to claim 15, wherein said total thickness is about eight mils.

17. The wraparound, protective eyewear according to claim 9, wherein said transparent, base layer and said transparent, top layer are secured to said solar filter material layer by lamination.

18. (canceled)

19. (canceled)

20. The wraparound, protective eyewear according to claim 17, wherein a total thickness of said thickness of said solar filter material layer, a thickness of said transparent, base layer, and a thickness of said transparent, top layer is about seven mils to about nine mils.

21. The wraparound, protective eyewear according to claim 20, wherein said total thickness is about eight mils.
